(19) United States
(12) Patent Application Publication
(10) Pub. No.: US 2020/0401967 A1
(43) Pub. Date: Dec. 24, 2020

(54) IMPROVED RESOURCE NEED FORECASTING TOOL

(71) Applicant: Walmart Apollo, LLC, Bentonville, AR (US)

(72) Inventors: Akash Verma, Bengaluru (IN); Harshavardhan Yeruva, Telangana, IN (US); Kosha Modi, Kolkata (IN)

(21) Appl. No.: 16/547,563

(22) Filed: Aug. 22, 2019

(30) Foreign Application Priority Data
Jun. 24, 2019 (IN) 201941025034

(51) Int. Cl. G06Q 10/06; G06N 20/00; G06Q 10/08

(52) U.S. Cl. CPC G06Q 10/06315; G06Q 10/087; G06N 20/00

(57) ABSTRACT

An improved resource need forecasting tool enables more accurate forecasts by leveraging models (e.g., machine learning models) of short-term phenomena such as rapid growth that, if not properly accounted for, can distort forecasts. Improved forecasting provides more reliable labor need projections, and includes receiving activity data for a facility; producing normalized activity data adjusted for the short-term phenomena; forecasting, based at least on the normalized activity data, predicted activity data; adjusting, based at least on an activity cannibalization index, the predicted activity data for the first facility to produce adjusted predicted activity data; adjusting, the adjusted predicted activity data based at least on the short-term phenomena; and generating a resource need report.

### BACKGROUND

Forecasting is used to assist enterprises with scheduling resource use efficiently, such as by having sufficient resources (e.g., labor force and inventory levels) in place when needed, but not to the extent of wasted excess. Common forecasting techniques take into account historical data, in order to project likely future activity levels. Unfortunately, short-term phenomena that affect recent history, but are likely to change in the future, can contribute to errors in the forecasts, if not properly accounted for.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

An improved resource need forecasting tool enables more accurate forecasts by leveraging models (e.g., machine learning models) of short-term phenomena such as rapid growth that, if not properly accounted for, can distort forecasts. Improved forecasting provides more reliable labor need projections, and includes receiving activity data for a facility; producing normalized activity data adjusted for the short-term phenomena; forecasting, based at least on the normalized activity data, predicted activity data; adjusting, based at least on an activity cannibalization index, the predicted activity data for the first facility to produce adjusted predicted activity data; adjusting, the adjusted predicted activity data based at least on the short-term phenomena; and generating a resource need report.

### BRIEF DESCRIPTION OF THE DRAWINGS

The disclosed examples are described in detail below with reference to the accompanying drawing figures listed below:

FIG. 1 illustrates an exemplary resource need forecasting tool, including associated sensors;

FIG. 2 is a plot of an exemplary forecasting error condition that is remedied by the resource need forecasting tool of FIG. 1;

FIG. 3 is a plot of an exemplary forecasting error source that produces the error condition of FIG. 2;

FIG. 4 is a plot of another exemplary forecasting error condition that is remedied by the resource need forecasting tool of FIG. 1;

FIG. 5 illustrates a schematic view of an exemplary forecasting error scenario that produces the error condition of FIG. 4;

FIG. 6 illustrates various exemplary phases of forecasting associated with the resource need forecasting tool of FIG. 1;

FIG. 7 illustrates exemplary data sets used to determine a seasonality index;

FIG. 8 is a plot of activity data along with de-seasonalized activity data;

FIG. 9 illustrates exemplary data sets used as an activity cannibalization index;

FIG. 10 illustrates exemplary data sets used as an annual factors index;

FIG. 11 illustrates exemplary data sets used as an external factors index;

FIG. 12 shows a flow chart of exemplary operations associated with the resource need forecasting tool of FIG. 1;

FIG. 13 shows another flow chart of exemplary operations associated with the resource need forecasting tool of FIG. 1; and

FIG. 14 is a block diagram of an example computing node for implementing aspects disclosed herein.

Corresponding reference characters indicate corresponding parts throughout the drawings. Elements in the figures are illustrated for simplicity and clarity and have not necessarily been drawn to scale. For example, the dimensions and/or relative positioning of some of the elements in the figures may be exaggerated relative to other elements to help to improve understanding. Also, common but well-understood elements that are useful or necessary in a commercially feasible embodiment may not be depicted, in order to facilitate a less obstructed view.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity, this implied leading clause is not repeated ad nauseum.

Forecasting is used to assist enterprises with scheduling resource use efficiently, such as by having sufficient resources (e.g., labor force and inventory levels) in place when needed, but not to the extent of wasted excess. Common forecasting techniques take into account historical data, in order to project likely future activity levels. Unfortunately, short-term phenomena that affect recent history, but are likely to change in the future, can contribute to errors in the forecasts, if not properly accounted for. One example is an initial rapid growth stage for a new service, that will eventually taper off as the market matures. Another error-causing phenomenon is cannibalization when a retailer with multiple facilities initially offers a service at a first facility and then begins offering the same service at a nearby second facility that draws from the same pool of customers. Some of the customers that had been patronizing the first facility for the service will begin patronizing the second facility, if it is closer, thereby dropping the activity level at the first facility.

Therefore, an improved resource need forecasting tool enables more accurate forecasts by leveraging models (e.g., machine learning (ML) models) of short-term phenomena such as rapid growth that, if not properly accounted for, can distort forecasts. Improved forecasting provides more reliable labor need projections, and includes receiving activity data for a facility; producing normalized activity data adjusted for the short-term phenomena; forecasting, based at least on the normalized activity data, predicted activity data; adjusting, based at least on an activity cannibalization index, the predicted activity data for the first facility to produce adjusted predicted activity data; adjusting, the adjusted predicted activity data based at least on the short-term phenomena; and generating a resource need report.

Examples forecast a number of online pickup orders to enable scheduling labor hours to more reliably fit the demand. Data is uses from facilities (e.g., retail stores) with a minimum available history of online pickup order operations, or other activity level. A seasonality index is calculated to adjust for fluctuations and used to improve the forecast. Some examples use an order using the seasonality index. Some examples calculate the forecast using a Bayesian structural time series (BSTS) model, which is an ML technique. Some examples adjust the forecast to account for cannibalization and future seasonal events. These techniques are applicable to new services that tend to grow rapidly shortly after introduction, and in multi-location retail settings in which different facilities bring the service on-line at different times.

For example, a tool or vehicle rental service can leverage the teachings herein to forecast the inventory level need for rental units, in order to acquire or dispose of units in an efficient manner. A temporary labor services supplier can leverage the teachings herein to forecast the size of the labor force at various times. Other applications are also possible.

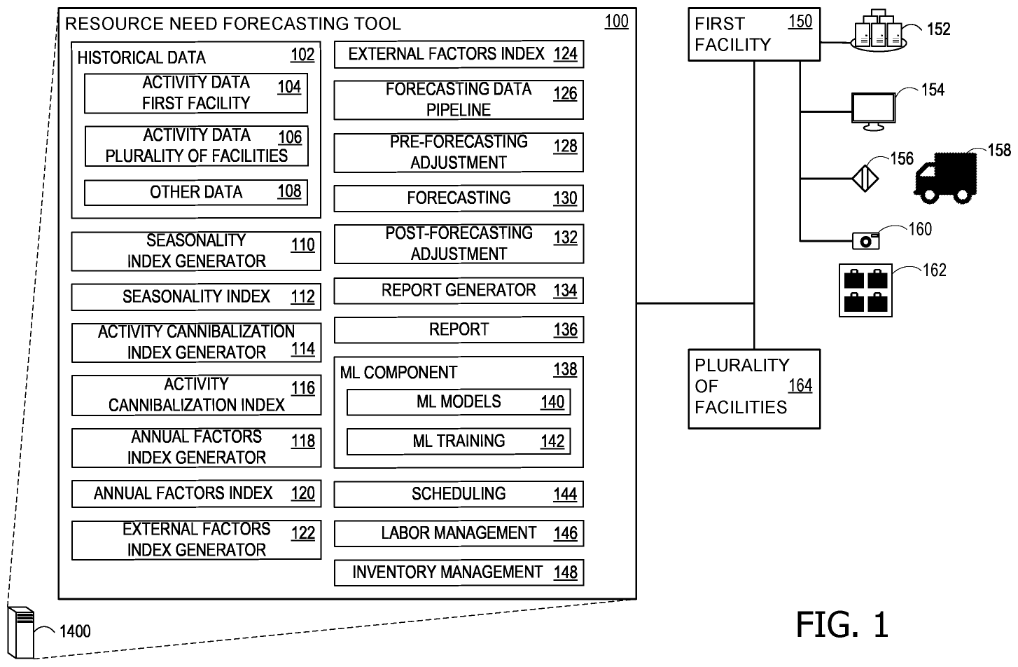

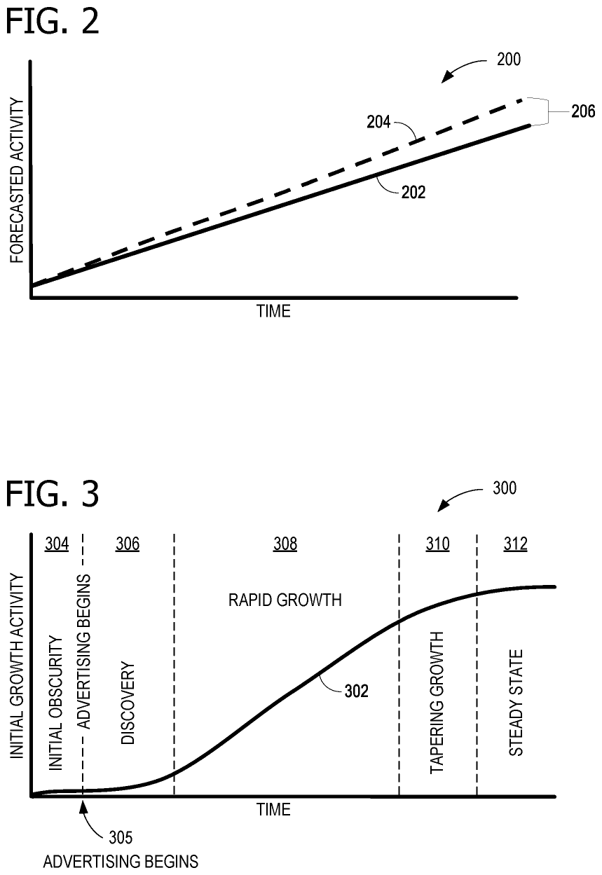

FIG. 1 illustrates an exemplary resource need forecasting tool 100, including associated sensors. However, the advantages provided by resource need forecasting tool 100 will be more readily understood in view of the forecasting error sources and conditions described in relation to FIGS. 2-5. FIG. 2 is a plot 200 of an exemplary forecasting error condition that is remedied by resource need forecasting tool 100. An ideal forecasting curve 202 reflects forecasted activity level relative to time for a theoretical ideal forecasting tool that has no errors. Unfortunately, an error source causes a non-ideal forecasting tool to produce an errored forecasting curve 204, having an error 206. In this example, the error source is short-term rapid growth, illustrated in FIG. 3. In general, forecasting tools use historic growth trends as at least a part of the basis for predicting future growth.

FIG. 3 is a plot 300 of an exemplary activity growth, upon a service, such as online order pickup, initially becoming available at a particular retail location. A growth curve spans several phases of initial growth. Upon initial launch of the service, there is a period 304 of initial obscurity, until an advertising event 305, such as an advertising campaign of a significant size, alerts potential customers to the availability of the service. A period 306 of initial discovery ensues as some customers test out the service and is followed by a period 308 of rapid growth as more customers learn about the service and begin using it. As the customer reach nears saturation, a period 310 of tapered growth begins, and then the service settles into a period 312 of steady state performance that can sustain a relatively stable long-term growth rate. During periods 306-310, when the growth rate is higher than the growth rate in period 312, if a forecasting tool uses the observed (too high) growth rate, without compensating for a likely future decrease, the forecasted growth rate is likely to be erroneous and too high, such as is reflected by error 206.

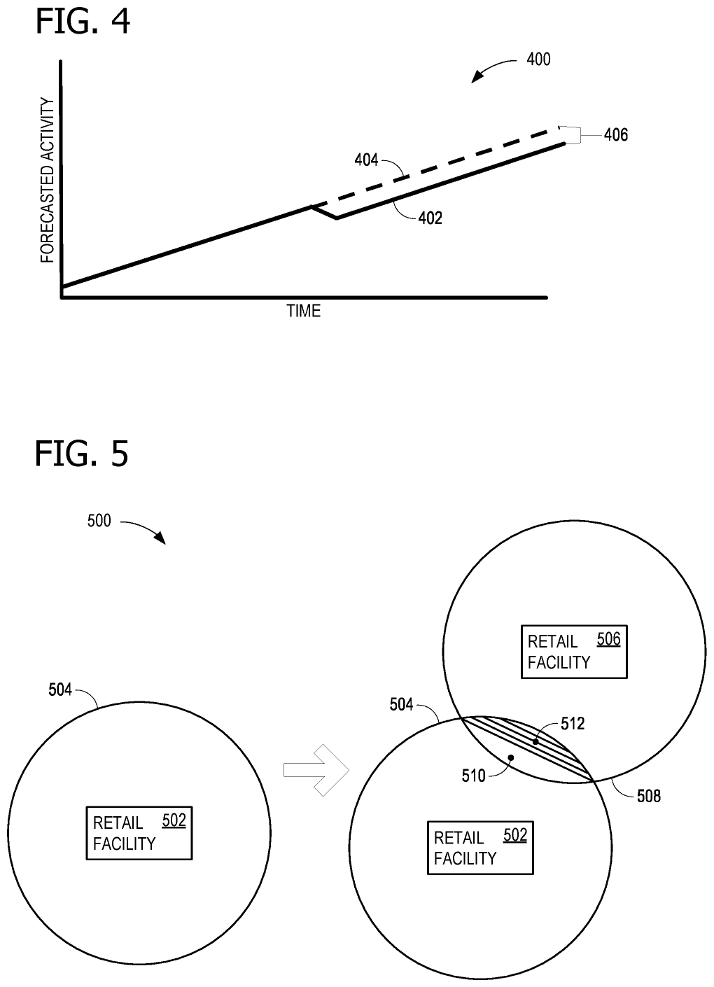

FIG. 4 is a plot 400 of another exemplary forecasting error condition that is remedied by resource need forecasting tool 100. An ideal forecasting curve 402 reflects forecasted activity level relative to time for a theoretical ideal forecasting tool that has no errors. Unfortunately, an error source causes a non-ideal forecasting tool to produce an errored forecasting curve 404, having an error 406. In this example, the error source is activity cannibalization, illustrated in FIG. 5.

FIG. 5 is a schematic view 500 of an exemplary activity cannibalization scenario, upon a nearby competing service initially becoming available at another retail location. A first retail facility 502 offers a service and has a draw radius 504 for customers. At some point in time, a second retail facility 506 begins offering a competitive service and has a draw radius 508 for customers. Draw radius 508 overlaps with draw radius 504. Customers within overlap region 510 will likely continue patronizing first retail facility 502, whereas customers within shaded overlap region 512 will likely stop patronizing first retail facility 502 and instead begin patronizing second retail facility 506. Thus, first retail facility 502 is likely to experience a decline in activity level. A forecasting tool that does not account for this activity cannibalization phenomena is likely to forecast activity erroneously and too high, such as is reflected by error 406.

Returning now to FIG. 1, a resource need forecasting tool 100 receives activity data for a first facility 150 from a data acquisition sensor, such as a sales transaction register 154, an instrumented e-commerce website 152, a container sensor 160, and an automobile drive-up sensor 156. E-commerce website 152 receives orders for goods and/or services, such as on-line grocery orders. In some examples, the activity recorded includes the number of discrete orders placed by various customers and/or the number of items within all of the orders. Sales transaction register 154 process sales transactions when customers arrive to pick up on-line orders that had been placed with e-commerce website 152. In some examples, the activity recorded includes the number of sales transactions. Automobile drive-up sensor 156 registers an automobile 158 arriving to pick up ordered items. In some examples, the activity recorded includes the number of vehicles arriving to pick up orders. Container sensor 160 can include an optical sensor and/or a weight sensor that ascertains the quantity of goods to be delivered to arriving customers in containers 162. In some examples, the activity recorded includes the number of containers 162 handled. Activity data is indexed and archived as historical data not only by date, but also by time of day, so that forecasting can be accomplished with an hourly resolution, or even finer, in some examples. Resource need forecasting tool 100 also receives activity data from a data acquisition sensor for a plurality of other facilities 164 that is collected similarly to activity data for first facility 150.

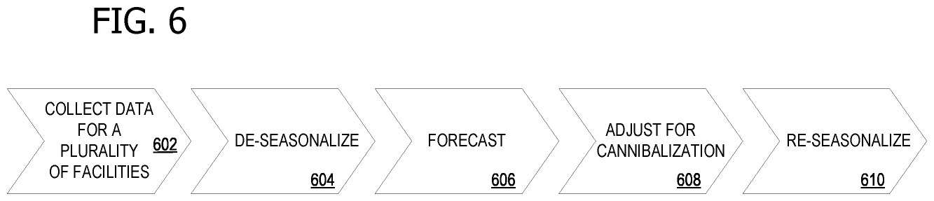

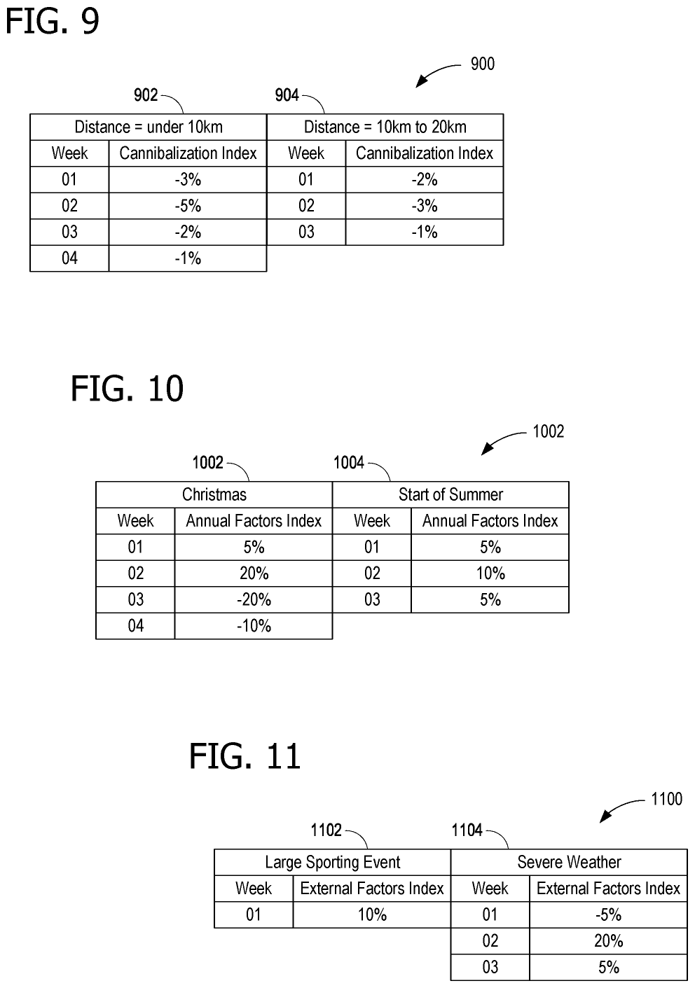

Resource need forecasting tool 100 has several logical and data components used to provide the improved forecasting described herein. Historical data 102 includes activity data 104 for first facility 150 (such as from one or more of data acquisition sensors 152, 154, 156, and 162). Historical data 102 also includes activity data 106 for plurality of other facilities 164. Historical data 102 further includes other data 108, such as data related to activity cannibalization (e.g., nearby facility start dates and distances), annual factors (e.g., holidays and seasonal fluctuations), and external factors. A seasonality index generator 110 determines a seasonality index 112, based at least on historical data 102, as is described in further detail in relation to FIGS. 6-8. An activity cannibalization index generator 114 determines an activity cannibalization index 116, based at least on historical data 102, as is described in further detail in relation to FIG. 9. An annual factors index generator 118 determines an annual factors index 120, based at least on historical data 102, as is described in further detail in relation to FIG. 10. An external factors index generator 122 determines an external factors index 124, based at least on historical data 102, as is described in further detail in relation to FIG. 11.

A forecasting data pipeline 126 holds activity data as it transitions through various phases from input activity data through output forecasted activity data. That is, a pre-forecasting adjustment component 128, a forecasting component 130, and a post-forecasting adjustment component 132 operate on data within forecasting data pipeline 126. Specifically, pre-forecasting adjustment component 128 de-seasonalizes, based at least on seasonality index 112, activity data 104 for first facility 150 to produce normalized activity data for first facility 150. Forecasting component 130 forecasts, based at least on the normalized activity data for first facility 150, predicted activity data for first facility 150. Post-forecasting adjustment component 132 adjusts, based at least on activity cannibalization index 116, the predicted activity data for first facility 150 to produce adjusted predicted activity data for first facility 150. Post-forecasting adjustment component 132 also adjusts, based at least on seasonality index 112, the adjusted predicted activity data for first facility 150 to produce re-seasonalized predicted activity data for first facility 150. In some examples, post-forecasting adjustment component 132 also adjusts, based at least on annual factors index 120 and/or external factors index 124, the adjusted predicted activity data for first facility 150 to produce adjusted predicted activity data for first facility 150. Pre-forecasting adjustment component 128, forecasting component 130, and post-forecasting adjustment component 132 also operate on activity data 106 for plurality of other facilities 164 to produce predicted activity data for plurality of other facilities 164.

A report generator 134 generates, based at least on the re-seasonalized predicted activity data for first facility 150 (which is also further adjusted by annual factors index 120 and/or external factors index 124), a resource need report 136. Report generator 134 also generates equivalent resource need reports for one or more of plurality of other facilities 164. In some examples, the resource need is at least one need at the first facility selected from the list consisting of: a labor need and an inventory need. A scheduling component 144 schedules, based at least on resource need report 136, at least one resource. In this way, resource need report 136 is leveraged for the practical task of resource scheduling, such as labor scheduling, inventory acquisition, maintenance services, and others. In some examples, the labor scheduling has a granularity down to an hour. In some examples, a labor management 146 and an inventory management component 148 convert resource scheduling into practical products, such as work schedules and inventory purchase requests.

An ML component 138 includes at least one ML model (in ML models 140) selected from the list consisting of: a forecasting ML model, a seasonality index generation ML model, and an activity cannibalization index generation ML model. Any or all of seasonality index generator 110, activity cannibalization index generator 114, annual factors index generator 118, external factors index generator 122, and forecasting component 130 can leverage ML and artificial intelligence (AI) for improved performance, through ML component 138. An ML training component 142 leverages historical data 102 for training at least one ML model in ML models 140. In some examples, ML training component 142 includes a feedback loop for receiving feedback, such as input from an operator, regarding whether a predicted (forecasted resource need) was too high or too low.

FIG. 6 illustrates various exemplary phases of forecasting associated with resource need forecasting tool 100. A first phase 602 includes collecting historical data (e.g., historical activity data) and cleaning the data, such as by discarding data for facilities having less than a threshold number of weeks' worth of activity data. In some examples, the threshold is 10 weeks for forecasting, and the threshold for using data to generate a seasonality index is 52 weeks. That is, in some examples, a different (smaller) set of facilities is used for generating a seasonality index (and also activity cannibalization, annual factors, and external factors indices) than is used for forecasting. Historical activity data is stored in designated databases. In some examples, the data granularity is store number, week number, and number of orders. In some examples, the data granularity has a different time period and/or additional data. In some examples, a scheduled update job runs on a weekly basis to update the historical data with newly collected data.

A second phase 604 de-seasonalizes the collected activity data, which addresses seasonal fluctuations and accounts for rapid growth, so that forecasting results are not negatively impacted. In some examples, de-seasonalizing applies the following equation:

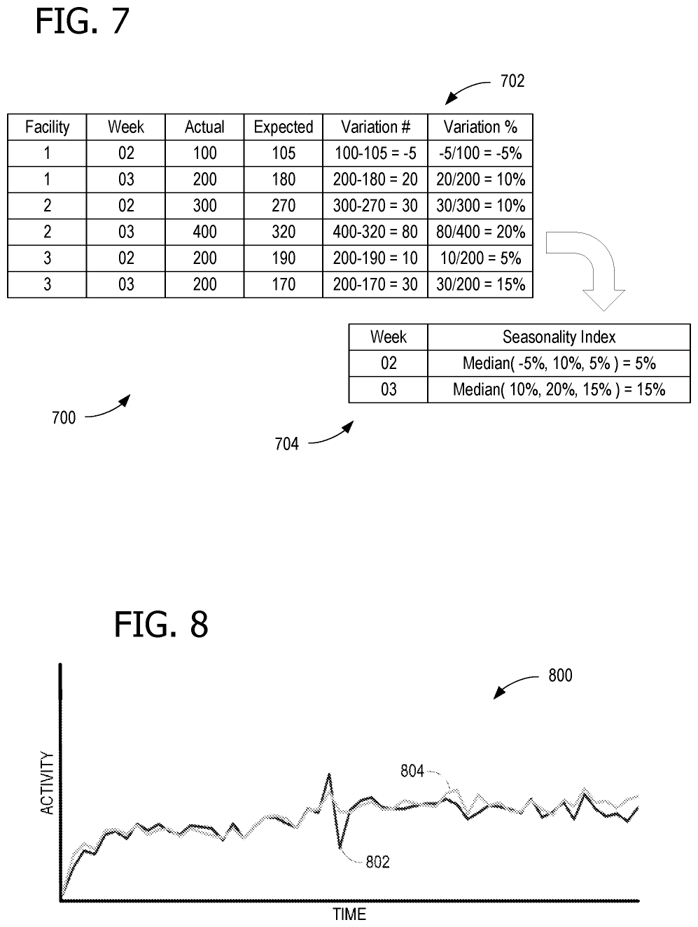

A=A×(1−SI) Eq. (1)

Where A is the activity level and SI is the seasonality index. In some examples, Eq. (1) is applied on a week-by-week basis. In some examples, a different time baseline is used. The calculation of SI, the seasonality index (e.g., seasonality index 112 of FIG. 1) is described in more detail in relation to FIG. 7.

A third phase 606 forecasts predicted activity. In some examples, a BSTS ML technique is used for forecasting. ML allows for extensions beyond linear models. In some examples, a user is able to select the time period for which forecasts are to be generated. Users are also able to upload a file with future online grocery pickup launch dates, in order to estimate expected cannibalization. A fourth phase 608 adjusts for activity cannibalization using an activity cannibalization index (e.g., activity cannibalization index 116 of FIG. 1), similarly to Eq. (2) shown below. For example, launching a duplicate activity at another facility with a threshold radius of a facility already offering the service is likely to result in the newly launched activity taking customers who are closer to the other facility (or otherwise find it more convenient. The distance at which activity cannibalization is a noticeable effect can vary by geography. A fifth phase 610 re-seasonalizes the (forecasted) predicted activity data, to re-introduce the effects of rapid growth of a new service. In some examples, re-seasonalizing applies the following equation:

A=A×(1+SI) Eq. (2)

FIG. 7 illustrates exemplary data sets 700 used to determine a seasonality index (e.g., seasonality index 112 of FIG. 1). Historical activity data is collected from a plurality of facilities and indexed by facility and week. In some examples, a different time base is used. In the example of table 702, activity data is shown for three facilities (facility 1, facility 2, and facility 3) covering two weeks (numbered week 02 and week 03). It should be understood that in some examples, historical activity data covers a considerably larger number of facilities and a much longer time period. The data shown in tables 702 and 704 is for explanatory purposes. Actual activity data, collected form historical data sources, is shown for each facility for each week. Expected activity is determined for each facility for each tie period (here, weekly). In some examples, the expected activity is determined using a compounded weekly growth rate (CWGR) calculated according to the following equation:

CWGR=(A(week n)/A(week n−52))^{1/52}−1 Eq. (3)

Eq. (3) shows that the activity level at some week is divided by the activity level 52 weeks (one year) earlier, and exponentiated by the inverse of 52 (for 52 weeks in a year). Then, one is subtracted from this value, to put it into a value range that can be expressed as a decimal percentage (e.g., 5% rather than 1.05). This is used to determine an expected activity for each facility for each week. For example, a starting value is multiplied by the CWGR to determine the activity level that would occur if the activity followed a constant growth pattern. A variation is determined, for each facility for each time period (e.g., week), between the actual activity and the expected activity. Table 702 shows the variation as both a raw number and also as a percentage.

The variations are grouped according to week number (or other time period base) for each facility. In some examples, the week numbers are relative, based on when each facility began the activity. Thus, for example, week 02 for facility 2 could be the same calendar week as week 03 for facility 1, if facility 2 began the activity a week later than facility 1. In some examples, however, the time periods are aligned by calendar date. Using the groupings of variations by facility, the seasonality index for each week number is determined. That is, the seasonality index is determined based at least on the variations for the plurality of facilities. In the example shown in table 704, the seasonality index for each week is the median variation value across the plurality of facilities (used in the determination) for each week.

FIG. 8 is a plot 800 of activity data along with de-seasonalized (normalized) activity data. The raw activity data is plotted in curve 802, which shows a higher degree of fluctuation than the de-seasonalized activity data plotted in curve 804. In some examples, curve 804 is produced by applying Eq. (1) to the data of curve 802. Conversely, an equivalent of curve 802 for predicted data can be produced by applying Eq. (2) to the predicted data equivalent of curve 804.

FIG. 9 illustrates exemplary data sets 900 used as an activity cannibalization index (e.g., activity cannibalization index 116 of FIG. 1). A first portion 902 provides activity adjustment percentages on a weekly basis for four weeks for a competing activity beginning within 10 kilometers (km). This indicates that, when a competing activity begins within 10 km, activity at the facility for which the forecast is being produced, will drop 3% the first week, 5% the second week, 2% the third week, and 1% the fourth week. A second portion 904 provides activity adjustment percentages on a weekly basis for three weeks for a competing activity beginning between 10 km and 20 km distant. It should be understood that these are merely exemplary numbers, and real measured data may vary significantly.

FIG. 10 illustrates exemplary data sets 1000 used as an annual factors index (e.g., annual factors index 120 of FIG. 1). A first portion 1002 provides activity adjustment percentages on a weekly basis for four weeks for the Christmas holiday. In different geographical regions, the annual factors index can vary. For example, the Christmas holiday will have reduced impact in certain countries. A second portion 1004 provides activity adjustment percentages on a weekly basis for three weeks for the start of summer. In different geographical regions, for example in the northern hemisphere versus the southern hemisphere, annual seasons will differ in both time (which week of the year) and may also differ in impact on activity. It should be understood that these are merely exemplary numbers, and real measured data may vary significantly.

FIG. 11 illustrates exemplary data sets 1100 used as an external factors index (e.g., external factors index 124 of FIG. 1). External factors include, for example, sporting events and even advertising event 305 (of FIG. 3). A first portion 1102 provides activity adjustment percentages on a weekly basis for a single week for a large sporting event, such as a play-off game. A second portion 1004 provides activity adjustment percentages on a weekly basis for three weeks for a severe inclement weather event. An external factors index will be highly tailored to geographical and cultural regions. It should be understood that these are merely exemplary numbers, and real measured data may vary significantly.

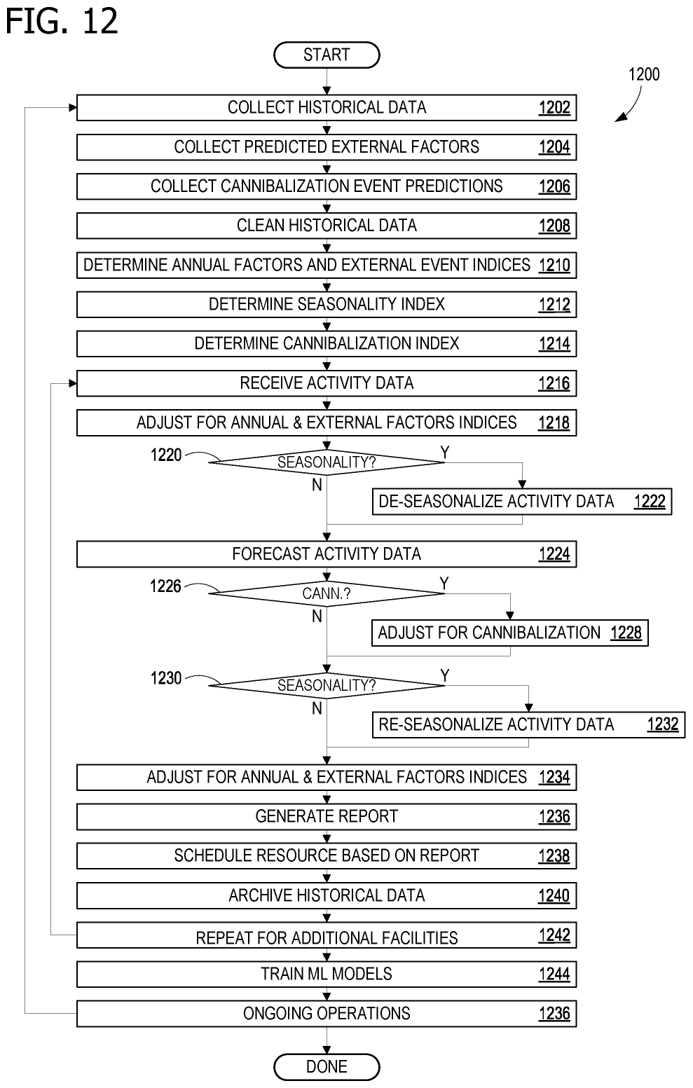

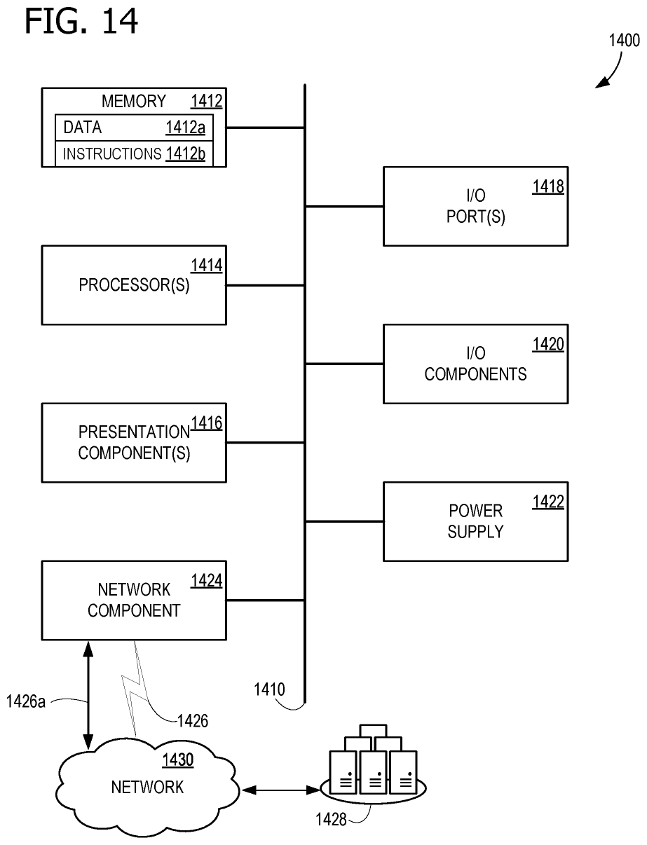

FIG. 12 shows a flow chart 1200 of exemplary operations associated with resource need forecasting tool 100. In some examples, some or all of flow chart 1200 is performed as computer-executable instructions on computing node 1400 (see FIG. 14). Flow chart 1200 commences with operation 1202, which includes collecting historical data from a plurality of facilities. In some examples, the activity is an online order pickup activity. In some activities, the activity is an online grocery sales pickup. The activity can be tracked by a variety of metrics, such as number of orders and number of bins used for all orders. Activity can be tracked on an hourly, daily, and weekly basis. Predicted external factors are collected in operation 1204, for example upcoming sporting events and advertising campaign kick-offs. Cannibalization event predictions are collected in operation 1206, such as the dates that nearby stores will begin offering similar services.

Operation 1208 includes cleaning historical data, to use the most suitable data for making adjustments to the forecasts. In some examples, historical data is used for generating (determining) the seasonality index only if there is at least 52 weeks of data. In some examples, the threshold is 10 weeks. Operation 1210 includes determining the annual factors index and determining the external factors index. In some examples, this involves using an ML model for determining one or both indices. In some examples, the annual factors index, which includes calendar seasons (e.g., summer, spring, fall, and winter) and holidays (e.g., Christmas), is unlikely to change much, but can be altered to account for long term trends. Operation 1212 includes determining the seasonality index, which is described in more detail in relation to flow chart 1300. That is, operation 1212 encompasses flow chart 1300. In some examples, operation 1212 involves using an ML model to determine the seasonality index. Operation 1214 includes determining the activity cannibalization index, which in some examples, involves using an ML model. Operation 1214 also includes determining the length of time for which an activity cannibalization index should be applied to forecasting results.

Whereas operations 1202-1214, and also operations 1244 and 1246, occur for the aggregate set of facilities involved, operations 1216-1244 occur for individual facilities, and are thus repeated for the different facilities. Operation 1216 includes receiving activity data for a first facility from a data acquisition sensor, and also other facilities upon further iteration of operation 1216. In some examples, the data acquisition sensor comprises at least one sensor selected from the list consisting of: a sales transaction register, an instrumented e-commerce website, a container sensor, and an automobile drive-up sensor. In some examples, multiple sensors are used. In some examples, the first facility is not within the plurality of facilities used for calculating the seasonality index. That is, in some examples, the plurality of facilities excludes the first facility. This can occur when the activity at the first facility is so new that the threshold level of data has not yet been accumulated for using the historical data in the calculations. However, the threshold for using activity data to generate forecasts can be lower than the threshold for using data to determine the seasonality index, in some examples. In some examples, the thresholds are the same. Operation 1218 includes adjusting the received activity data, based at least on the annual factors index and the external factors index.

Due to the nature of the seasonality index, it is generally more applicable in early phases of the activity. Decision operation 1220 determines whether the seasonality index should apply, for example if the activity is still within the initial time period after which the activity began, which is shorter than the seasonality index. If so, then operation 1222 includes de-seasonalizing, based at least on a seasonality index, the activity data for the first facility to produce normalized activity data for the first facility. Operation 1224 includes forecasting, based at least on the normalized activity data for the first facility, predicted activity data for the first facility. In some examples, this involves using an ML model.

Due to the nature of the activity cannibalization index, it is generally more applicable shortly after activity has begun at another facility in the vicinity. Decision operation 1226 determines whether the activity cannibalization index should apply, for example if the activity is still within the initial time period after which the activity began at the other facility, which is shorter than the activity cannibalization index. If so, then operation 1228 includes adjusting, based at least on an activity cannibalization index, the predicted activity data for the first facility to produce adjusted predicted activity data for the first facility. Decision operation 1230 follows the results of decision operation 1220 and, if the seasonality index should apply, operation 1232 includes adjusting, based at least on the seasonality index, the adjusted predicted activity data for the first facility to produce re-seasonalized predicted activity data for the first facility. Operation 1232 can be described as re-seasonalizing the activity data. Operation 1234 includes adjusting, based at least on the annual factors index, the re-seasonalized predicted activity data for the first facility. Operation 1234 also includes adjusting, based at least on the external factors index, the re-seasonalized predicted activity data for the first facility.

Operation 1236 includes generating, based at least on the re-seasonalized predicted activity data for the first facility, a resource need report. In some examples, the resource need is at least one need at the first facility selected from the list consisting of: a labor need and an inventory need. Operation 1238 includes scheduling, based at least on the resource need report, at least one resource. In this way, the forecast is leveraged for the practical task of resource scheduling, such as labor scheduling, inventory acquisition, maintenance services, and others. In some examples, the labor scheduling has a granularity down to an hour. Historical data is archived in operation 1240, for collecting when flow chart 1200 returns to operation 1202. In some examples, this includes one or more of the following: tracking actual activity, tracking forecasted activity, compare actuals with predictions, tracking data related to cannibalization (e.g., another facility starting the activity and the distance to the other facility), and tracking data related to rapid growth (e.g., advertising expenditures). Operation 1242 repeats operations 1216-1242 for other facilities. Operation 1244 includes training the at least one ML model, based at least on the historical data collected from a plurality of facilities. In some examples, this includes one or more of a forecasting ML model, a seasonality index generation ML model, and an activity cannibalization index generation ML model. In some examples, operation 1244 includes receiving feedback, such as input from an operator, regarding whether a predicted (forecasted resource need) was too high or too low. Operation 1236 cycles through operations 1202-1244 as activities are ongoing.

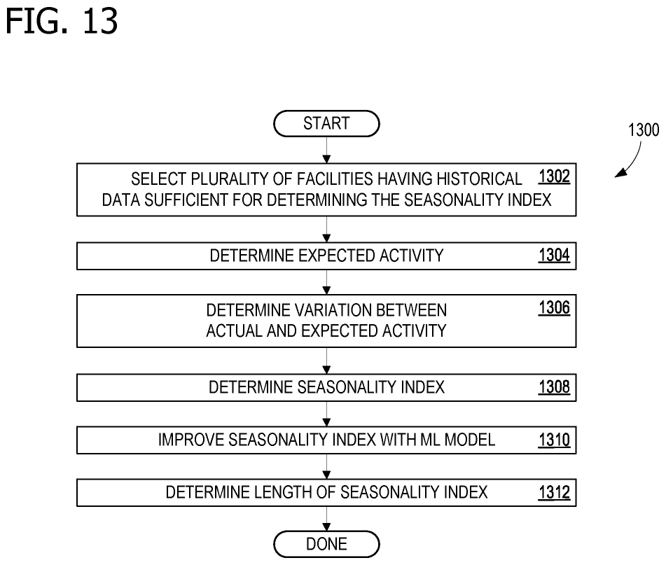

FIG. 13 shows a flow chart 1300 of exemplary operations associated with resource need forecasting tool 100, for example, operation 1212 of FIG. 12. In some examples, some or all of flow chart 1300 is performed as computer-executable instructions on computing node 1400 (see FIG. 14). Flow chart 1300 commences with operation 1302 with selecting a plurality of facilities having historical data sufficient for determining the seasonality index. In some examples, retail facilities having at least 52 weeks (one year) of historical activity data have a minimum threshold of data and are selected. Operation 1304 includes determining, for each facility within the plurality of facilities, an expected activity. In some examples, the expected activity is determined using a CWGR. Operation 1306 includes determining, for each facility within the plurality of facilities, a variation between actual activity and the expected activity. In some examples this includes two arithmetic operations: calculating the difference between the actual activity level (e.g., number of orders) and the expected activity, and then calculating the percentage difference. Operation 1308 includes determining, based at least on the variations for the plurality of facilities, the seasonality index. In some examples, the weekly seasonal indices are obtained by calculating the median at each weekly level. In some examples, this is a beginning seasonality index, which is used as a starting input for an ML model. Operation 1310 includes using an ML as part of determining (generating) the seasonality index. For example, the initial seasonality index is improved via ML to determine a final seasonality index ML model. Operation 1312 includes determining the length of the seasonality index, so that the effects of the short-term phenomenon have tapered off sufficiently that they no longer require tracking. In some examples, this includes the magnitude of the seasonality index for the final week being within the expected margin of error for the forecasting algorithm employed.

### Exemplary Operating Environment

FIG. 14 is a block diagram of an example computing node 1400 for implementing aspects disclosed herein and is designated generally as computing node 1400. Computing node 1400 is one example of a suitable computing environment and is not intended to suggest any limitation as to the scope of use or functionality of the invention. Neither should the computing node 1400 be interpreted as having any dependency or requirement relating to any one or combination of components/modules illustrated. The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing nodes, etc. The disclosed examples may also be practiced in distributed computing environments, where tasks are performed by remote-processing devices that are linked through communications network 1430.

Computing node 1400 includes a bus 1410 that directly or indirectly couples the following devices: memory 1412, one or more processors 1414, one or more presentation components 1416, input/output (I/O) ports 1418, I/O components 1420, a power supply 1422, and a network component 1424. Computing node 1400 should not be interpreted as having any dependency or requirement related to any single component or combination of components illustrated therein. While computing node 1400 is depicted as a seemingly single device, multiple computing nodes 1400 may work together and share the depicted device resources. That is, one or more computer storage devices having computer-executable instructions stored thereon may perform operations disclosed herein. For example, memory 1412 may be distributed across multiple devices, processor(s) 1414 may provide housed on different devices, and so on.

Bus 1410 represents what may be one or more busses (such as an address bus, data bus, or a combination thereof). Although the various blocks of FIG. 14 are shown with lines for the sake of clarity, delineating various components can be accomplished with various other schemes. For example, a presentation component such as a display device can also be classified as an I/O component. Additionally, processors have internal memory. Thus, the diagram of FIG. 14 is merely illustrative of an exemplary computing node that can be used in connection with one or more embodiments. Distinction is not made between such categories as “workstation,” “server,” “laptop,” “hand-held device,” etc., as all are contemplated within the scope of FIG. 14 and the references herein to a “computing node” or a “computing device.” Memory 1412 may include any of the computer-readable media discussed herein. Memory 1412 is used to store and access data 1212a and instructions 1412b configured to carry out the various operations disclosed herein. In some examples, memory 1412 includes computer storage media in the form of volatile and/or nonvolatile memory, removable or non-removable memory, data disks in virtual environments, or a combination thereof.

Processor(s) 1414 may include any quantity of processing units that read data from various entities, such as memory 1412 or I/O components 1420. Specifically, processor(s) 1414 are programmed to execute computer-executable instructions for implementing aspects of the disclosure. The instructions may be performed by the processor, by multiple processors within the computing node 1400, or by a processor external to the client computing node 1400. In some examples, the processor(s) 1414 are programmed to execute instructions such as those illustrated in the flowcharts discussed below and depicted in the accompanying drawings. Moreover, in some examples, the processor(s) 1414 represent an implementation of analog techniques to perform the operations described herein. For example, the operations may be performed by an analog client computing node 1400 and/or a digital client computing node 1400.

Presentation component(s) 1416 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly among multiple computing nodes 1400, across a wired connection, or in other ways. Ports 1418 allow computing node 1400 to be logically coupled to other devices including I/O components 1420, some of which may be built in. Example I/O components 1420 include, for example but without limitation, a microphone, keyboard, mouse, joystick, game pad, satellite dish, scanner, printer, wireless device, etc.

In some examples, the network component 1424 includes a network interface card and/or computer-executable instructions (e.g., a driver) for operating the network interface card. Communication between the computing node 1400 and other devices may occur using any protocol or mechanism over any wired or wireless connection. In some examples, the network component 1424 is operable to communicate data over public, private, or hybrid (public and private) network 1430 using a transfer protocol, between devices wirelessly using short range communication technologies (e.g., near-field communication (NFC), Bluetooth® branded communications, or the like), or a combination thereof. Network component 1424 communicates over wireless communication link 1426 and/or a wired communication link 1426a to a cloud resource 1428 across network 1430. Various different examples of communication links 1426 and 1426a include a wireless connection, a wired connection, and/or a dedicated link, and in some examples, at least a portion is routed through the internet.

Although described in connection with an example computing node 1400, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing nodes, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device or computing node when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary system for resource need forecasting comprises: a data acquisition sensor located at a first facility; a processor; and a computer-readable medium storing instructions that are operative when executed by the processor to: receive activity data for the first facility from the data acquisition sensor; de-seasonalize, based at least on a seasonality index, the activity data for the first facility to produce normalized activity data for the first facility; forecast, based at least on the normalized activity data for the first facility, predicted activity data for the first facility; adjust, based at least on an activity cannibalization index, the predicted activity data for the first facility to produce adjusted predicted activity data for the first facility; adjust, based at least on the seasonality index, the adjusted predicted activity data for the first facility to produce re-seasonalized predicted activity data for the first facility; generate, based at least on the re-seasonalized predicted activity data for the first facility, a resource need report.

An exemplary method of resource need forecasting comprises: receiving activity data for a first facility from a data acquisition sensor; de-seasonalizing, based at least on a seasonality index, the activity data for the first facility to produce normalized activity data for the first facility; forecasting, based at least on the normalized activity data for the first facility, predicted activity data for the first facility; adjusting, based at least on an activity cannibalization index, the predicted activity data for the first facility to produce adjusted predicted activity data for the first facility; adjusting, based at least on the seasonality index, the adjusted predicted activity data for the first facility to produce re-seasonalized predicted activity data for the first facility; and generating, based at least on the re-seasonalized predicted activity data for the first facility, a resource need report.

An exemplary computer storage device has computer-executable instructions stored thereon for resource need forecasting, which, on execution by a computer, cause the computer to perform operations comprising: collecting historical data from a plurality of facilities; determining, for each facility within the plurality of facilities, an expected activity; determining, for each facility within the plurality of facilities, a variation between actual activity and the expected activity; determining, based at least on the variations for the plurality of facilities, a seasonality index; receiving activity data for a first facility from a data acquisition sensor, wherein the first facility is not within the plurality of facilities, and wherein the data acquisition sensor comprises at least one sensor selected from the list consisting of: a sales transaction register, an instrumented e-commerce website, a container sensor, and an automobile drive-up sensor; de-seasonalizing, based at least on the seasonality index, the activity data for the first facility to produce normalized activity data for the first facility; forecasting, based at least on the normalized activity data for the first facility, predicted activity data for the first facility; adjusting, based at least on an activity cannibalization index, the predicted activity data for the first facility to produce adjusted predicted activity data for the first facility; adjusting, based at least on the seasonality index, the adjusted predicted activity data for the first facility to produce re-seasonalized predicted activity data for the first facility; generating, based at least on the re-seasonalized predicted activity data for the first facility, a resource need report; using at least one ML model to perform a task selected from the list consisting of: forecasting predicted activity data for the first facility, determining the seasonality index, and determining the activity cannibalization index; and training the at least one ML model, based at least on the historical data collected from the plurality of facilities.

Alternatively, or in addition to the other examples described herein, examples include any combination of the following:
the data acquisition sensor comprises at least one sensor selected from the list consisting of: a sales transaction register, an instrumented e-commerce website, a container sensor, and an automobile drive-up sensor;
the activity is an online order pickup activity;
the resource need is at least one need at the first facility selected from the list consisting of: a labor need and an inventory need;
determining the seasonality index, based at least on historical data collected from a plurality of facilities;
the plurality of facilities excludes the first facility;
determining the seasonality index comprises: collecting the historical data from the plurality of facilities; determining, for each facility within the plurality of facilities, an expected activity; determining, for each facility within the plurality of facilities, a variation between actual activity and the expected activity; and determining, based at least on the variations for the plurality of facilities, the seasonality index;
at least ML model selected from the list consisting of: a forecasting ML model, a seasonality index generation ML model, and an activity cannibalization index generation ML model;
using at least ML model to perform a task selected from the list consisting of: forecasting predicted activity data for the first facility, determining the seasonality index, and determining the activity cannibalization index; and
training the at least one ML model, based at least on historical data collected from a plurality of facilities.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for resource need forecasting, the system comprising:
a data acquisition sensor located at a first facility;
a processor; and
a computer-readable medium storing instructions that are operative when executed by the processor to:
receive activity data for the first facility from the data acquisition sensor;
de-seasonalize, based at least on a seasonality index, the activity data for the first facility to produce normalized activity data for the first facility;
forecast, based at least on the normalized activity data for the first facility, predicted activity data for the first facility;
adjust, based at least on an activity cannibalization index, the predicted activity data for the first facility to produce adjusted predicted activity data for the first facility;
adjust, based at least on the seasonality index, the adjusted predicted activity data for the first facility to produce re-seasonalized predicted activity data for the first facility; and
generate, based at least on the re-seasonalized predicted activity data for the first facility, a resource need report.

2. The system of claim 1 wherein the data acquisition sensor comprises at least one sensor selected from the list consisting of:
a sales transaction register, an instrumented e-commerce website, a container sensor, and an automobile drive-up sensor.

3. The system of claim 1 wherein the activity is an online order pickup activity.

4. The system of claim 1 wherein the resource need is at least one need at the first facility selected from the list consisting of:
a labor need and an inventory need.

5. The system of claim 1 wherein the instructions are further operative to:
determine the seasonality index, based at least on historical data collected from a plurality of facilities.

6. The system of claim 5 wherein the plurality of facilities excludes the first facility.

7. The system of claim 5 wherein the instructions are further operative to:
collect the historical data from the plurality of facilities;
determine, for each facility within the plurality of facilities, an expected activity;
determine, for each facility within the plurality of facilities, a variation between actual activity and the expected activity; and
determine, based at least on the variations for the plurality of facilities, the seasonality index.

8. The system of claim 1 further comprising at least one machine learning (ML) model selected from the list consisting of:
a forecasting ML model, a seasonality index generation ML model, and an activity cannibalization index generation ML model.

9. The system of claim 8 wherein the instructions are further operative to:
train the at least one ML model, based at least on historical data collected from a plurality of facilities.

10. A method of resource need forecasting, the method comprising:
receiving activity data for a first facility from a data acquisition sensor;
de-seasonalizing, based at least on a seasonality index, the activity data for the first facility to produce normalized activity data for the first facility;
forecasting, based at least on the normalized activity data for the first facility, predicted activity data for the first facility;
adjusting, based at least on an activity cannibalization index, the predicted activity data for the first facility to produce adjusted predicted activity data for the first facility;
adjusting, based at least on the seasonality index, the adjusted predicted activity data for the first facility to produce re-seasonalized predicted activity data for the first facility; and
generating, based at least on the re-seasonalized predicted activity data for the first facility, a resource need report.

11. The method of claim 10 wherein the data acquisition sensor comprises at least one sensor selected from the list consisting of:
a sales transaction register, an instrumented e-commerce website, a container sensor, and an automobile drive-up sensor.

12. The method of claim 10 wherein the activity is an online order pickup activity.

13. The method of claim 10 wherein the resource need is at least one need at the first facility selected from the list consisting of:
a labor need and an inventory need.

14. The method of claim 10 further comprising:
determining the seasonality index, based at least on historical data collected from a plurality of facilities.

15. The method of claim 14 wherein the plurality of facilities excludes the first facility.

16. The method of claim 14 wherein determining the seasonality index comprises:
collecting the historical data from the plurality of facilities;
determining, for each facility within the plurality of facilities, an expected activity;
determining, for each facility within the plurality of facilities, a variation between actual activity and the expected activity; and
determining, based at least on the variations for the plurality of facilities, the seasonality index.

17. The method of claim 10 further comprising:
using at least one machine learning (ML) model to perform a task selected from the list consisting of:
forecasting predicted activity data for the first facility, determining the seasonality index, and determining the activity cannibalization index.

18. The method of claim 17 further comprising:
training the at least one ML model, based at least on historical data collected from a plurality of facilities.

19. One or more computer storage devices having computer-executable instructions stored thereon for resource need forecasting, which, on execution by a computer, cause the computer to perform operations comprising:
collecting historical data from a plurality of facilities;
determining, for each facility within the plurality of facilities, an expected activity;
determining, for each facility within the plurality of facilities, a variation between actual activity and the expected activity;
determining, based at least on the variations for the plurality of facilities, a seasonality index;
receiving activity data for a first facility from a data acquisition sensor, wherein the first facility is not within the plurality of facilities, and wherein the data acquisition sensor comprises at least one sensor selected from the list consisting of:
a sales transaction register, an instrumented e-commerce website, a container sensor, and an automobile drive-up sensor;
de-seasonalizing, based at least on the seasonality index, the activity data for the first facility to produce normalized activity data for the first facility;
forecasting, based at least on the normalized activity data for the first facility, predicted activity data for the first facility;
adjusting, based at least on an activity cannibalization index, the predicted activity data for the first facility to produce adjusted predicted activity data for the first facility;
adjusting, based at least on the seasonality index, the adjusted predicted activity data for the first facility to produce re-seasonalized predicted activity data for the first facility;
generating, based at least on the re-seasonalized predicted activity data for the first facility, a resource need report;
using at least one machine learning (ML) model to perform a task selected from the list consisting of:
forecasting predicted activity data for the first facility, determining the seasonality index, and determining the activity cannibalization index; and
training the at least one ML model, based at least on the historical data collected from the plurality of facilities.

20. The one or more computer storage devices of claim 19 wherein the activity is an online order pickup activity, and wherein the resource need is at least one need at the first facility selected from the list consisting of:
a labor need and an inventory need.
